(19) United States
(12) Patent Application Publication
(10) Pub. No.: US 2026/0048759 A1
(43) Pub. Date: Feb. 19, 2026

(54) OPEN VEHICLE

(71) Applicant: KTM AG, Mattighofen (AT)

(72) Inventors: Alina KUTTLER, Linz (AT); Colin BALLANTYNE, Asolo (AT); Serkan ATAMER, Dresden (DE); Robert ROSENKRANZ, Dresden (DE); M. Ercan ALTINSOY, Dresden (DE)

(21) Appl. No.: 19/319,219

(22) Filed: Sep. 4, 2025

Related U.S. Application Data
(63) Continuation of application No. PCT/AT2024/060076, filed on Feb. 29, 2024.

(30) Foreign Application Priority Data
Mar. 6, 2023 (AT) A 50163/2023

(51) Int. Cl. B60W 50/14; B60W 30/095; B62J 3/10; B62J 45/41

(52) U.S. Cl. CPC B60W 50/14; B60W 30/0956; B62J 3/10; B62J 45/41; B60W 2050/143; B60W 2300/362; B60W 2420/403; B60W 2420/408; B60W 2556/45

(57) ABSTRACT

An open vehicle includes a surroundings sensor and an evaluation unit. The evaluation unit is configured to cause, depending on a signal of the surroundings sensor, a sound output device to output a sound to warn the driver of the vehicle. The sound has at least one frequency component in a frequency range from 900 to 20000, in particular 1000 to 10000, hertz.

The present application is a continuation of International Application PCT/AT2024/060076 filed on Feb. 29, 2024. Thus, all of the subject matter of International Application PCT/AT2024/060076 is incorporated herein by reference.

### BACKGROUND OF THE INVENTION

The invention relates to an open vehicle with at least one surroundings sensor and an evaluation unit, wherein the evaluation unit is designed to cause a sound output device to output at least one sound to warn the driver of the vehicle depending on at least one signal from the at least one surroundings sensor. The invention further relates to a computer program product.

The use of sounds to warn a vehicle driver is common in many areas-on the road, rail, sea or in the air. When a dangerous situation occurs, the driver (or captain) is usually warned with a sound (acoustic signal)-often in conjunction with a visual signal. This usually indicates a mechanical or electronic malfunction in the vehicle or the vehicle's engine.

A malfunction of this type typically persists over a longer period of time. When a warning light appears on the dashboard, a driver may not notice the malfunction for a few seconds or even a few minutes.

In recent years, there have been many developments in driver assistance systems, where surroundings sensors detect the surroundings and assess whether a dangerous situation exists. Based on this, warnings or interventions in the vehicle or engine control can be made to avoid accidents. Due to advances in technology, there are now a variety of sensors that can be adapted to the space resources of motorcycles and support the development of driving assistants.

DE 10 2019 215 508 A1 discloses a warning system for motorcycles. A surroundings sensor determines the presence and location of other road users or other objects, in particular by determining an angle. If the angle of the front wheel exceeds a predefined angle, a warning is issued to avoid a collision with a detected object. The warning can be given acoustically, among other things.

DE 10 2018 126 916 A1 discloses a vehicle-to-vehicle communication system for motorcycles.

Braking of a motorcycle in front can be signaled to the rider of a following motorcycle by means of a visual or acoustic signal output by an output device of the following motorcycle.

When using these systems, a quick warning to the user is essential, in contrast to the vehicle or engine malfunctions mentioned above. In such dangerous situations, a driver has very little time to react. It is therefore necessary to warn a driver as quickly as possible about a potential or already occurring danger.

Acoustic signals (or sounds) are more suitable for this purpose than visual signals, as a driver perceives them immediately without having to look at a warning light. Acoustic signals are already very common in closed vehicles.

However, when used on open vehicles, especially motor-driven vehicles such as motorcycles, quads, buggies or convertibles, it cannot always be guaranteed that an acoustic signal will be heard or perceived due to the strong noise generated by the wind when driving at high speed.

Sounds output by sound output devices such as loudspeakers located on the vehicle itself are difficult to hear due to wind and the wearing of a helmet. An acoustic signal coming from a loudspeaker would have to be very loud and could therefore unintentionally distract or even frighten other road users, as well as the driver himself.

It is known to place sound output devices in the helmet so that the sound can be generated close to the rider's ear. Nevertheless, the noise generated by the wind is still present in the helmet. Sounds from sound output devices in the helmet can also often not be heard well, especially when driving at high speed.

### SUMMARY OF THE INVENTION

The object of the invention is to solve the problems mentioned. In particular, the object of the invention is to enable a warning of a driver of an open vehicle by means of at least one sound, wherein the warning triggers a reliable, fast and targeted reaction of the driver of an open vehicle.

According to the invention, the at least one sound has at least one frequency component in a frequency range of 900 to 20000 hertz. Preferably, all or a majority of the frequency components of the at least one sound are arranged in the frequency range. “Frequency components” of at least one sound are frequency components that are strong enough to be heard.

A sound with frequency components in this frequency range results in a reliable reaction from the driver of the open vehicle, since such a sound is easily heard by drivers.

This is because the volume of the wind decreases with increasing frequency, from about 60 to 90 hertz, which means that a sound with frequency components in the described frequency range can be more easily distinguished from the wind noise. The at least one sound is deep enough (frequency less than or equal to 20000 hertz) to be heard by most (human) drivers. In particular, the frequency range extends from 1000 to 10000 hertz. Sounds with frequencies in this range are more pleasant to listen to.

On the one hand, sound is a musical sound with a pitch, which in particular has essentially harmonic overtones. In addition, a sound within the meaning of the application can also be a combination of several individual sounds of different pitches. On the other hand, a sound can be a noise that has no harmonic overtones, or it can have noise components.

The sound can be transmitted to the driver via airborne sound or structure-borne sound.

The at least one sound has a sound pressure level (SPL), wherein the sound pressure level, preferably in third-octave bands, is preferably in a range of 50 to 110 decibels.

A sound in this sound pressure level frequency range results in a more reliable reaction from the driver of the open vehicle, since such a sound is typically loud enough (sound pressure level greater than or equal to 50 dB) to stand out from the wind noise.

The wind noise decreases in volume with increasing frequency. In terms of audibility compared to wind noise, high and loud sounds are preferable.

In addition, at least one sound is quiet enough (preferably sound pressure level in third-octave bands less than or equal to 110 dB) so as not to damage the driver's hearing. The frequency-dependent hearing damage limit is therefore not exceeded.

The at least one sound can therefore be reliably perceived at high speeds of up to 120 kilometers per hour, by drivers with or without earplugs and without causing any hearing damage. In other words, at least one, preferably all or a majority of the frequency component(s) and the sound pressure level are arranged within an imaginary region in a sound pressure level-frequency coordinate system, wherein the imaginary region is a rectangle with the corner points 110 decibels and 900 hertz, 110 decibels and 20000 hertz, 50 decibels and 20000 hertz and 50 decibels and 900 hertz.

To make perception even more reliable, frequency components at lower sound pressure levels are preferably arranged in a smaller frequency range. In a particularly preferred embodiment, it is provided that at least one, preferably all or a majority of the frequency component(s) and the sound pressure level of the at least one sound are arranged within an imaginary region in a sound pressure level-frequency coordinate system, wherein the imaginary region is a triangle with
a first corner point at 90 decibels and 900 hertz, and
a second corner point at 90 decibels and 20000 hertz, and
a third corner point at 50 decibels and 5000 hertz.

The corner points 9, 10 and 11 can vary in frequency by plus or minus 100 Hz depending on the driving speed, and the sound pressure level can also vary by plus or minus 10 dB depending on the driving speed.

Alternatives for the first corner point would be 80 decibels and 800 hertz or 100 decibels and 800 hertz.

Alternatives for the second corner point would be 80 decibels and 19000 hertz or 100 decibels and 21000 hertz.

Alternatives for the third corner point would be 60 decibels and 5000 hertz or 40 decibels and 5000 hertz.

The sound pressure level of a frequency component can be determined by recording the signal, for example with a sound pressure level meter, digitizing the signal and mathematically applying a fast Fourier transform (FFT) to the digitized signal. In particular, the FFT can have a resolution (“FFT size”) of 4096 bins in the frequency range from 20 to 20000 Hz. In this way, a sound pressure level value can be assigned to a frequency component (with finite resolution).

In particular, this restricted range in the sound pressure level-frequency coordinate system improves the perception of lower sound pressure levels in the described range. This ensures that all drivers hear the warning sound.

The range is adapted, through the triangular shaping to the frequency dependence of the perception limit of older drivers and to the frequency dependence of the volume of the wind noise. The perception threshold of older people increases with frequency (higher frequencies are harder to hear and need to be louder), while the volume of wind noise decreases with frequency (lower frequencies are more masked by wind noise and need to be louder). At low and high frequencies in the frequency range from 900 to 20000 hertz, higher sound pressure levels are therefore required, which results in the triangular shaping.

The human ear processes sounds in frequency bands, for example octave bands or third-octave bands. A warning tone (or sound) can be distinguished clearly from background noise if the band sound pressure level (sound pressure level of at least one sound in a frequency band) in at least one frequency band is at most 6 decibels below the corresponding band sound pressure level (“band sound pressure level”) of the background noise. For high frequency bands, the perception threshold for older people is crucial for the audibility of at least one sound.

In a preferred embodiment, the band sound pressure level of a third-octave band (or ⅓-octave band) of the at least one sound with a center frequency located in the frequency range (defined above) is in a range of 50 to 105 decibels.

In particular, the band sound pressure level of a third octave band of the at least one sound has, with a central frequency
of 1000 hertz a band sound pressure level in a range of 87.0 to 92.7 decibels, and/or
of 1250 hertz a band sound pressure level in a range of 83.4 to 93.7 decibels, and/or
of 1600 hertz a band sound pressure level in a range of 81,1 to 94.7 decibels, and/or
of 2000 hertz a band sound pressure level in a range of 78.6 to 95.6 decibels, and/or
of 2500 hertz a band sound pressure level in a range of 76.9 to 96.6 decibels, and/or
of 3150 hertz a band sound pressure level in a range of 75.6 to 97.7 decibels, and/or
of 4000 hertz a band sound pressure level in a range of 70.7 to 98.7 decibels, and/or
of 5000 hertz a band sound pressure level in a range of 65.5 to 99.7 decibels, and/or
of 6300 hertz a band sound pressure level in a range of 61.4 to 100.7 decibels, and/or
of 8000 hertz a band sound pressure level in a range of 70.9 to 101.7 decibels, and/or
of 10000 hertz a band sound pressure level in a range of 74.7 to 102.7 decibels, and/or
of 12500 hertz a band sound pressure level in a range of 84.0 to 103.7 decibels, and/or
of 16000 hertz a band sound pressure level in a range of 87.7 to 104.7 decibels.

By selecting the lower limit for the band sound pressure level, at least one sound in each frequency band stands out audibly from the driving noise and is also audible to older people. By choosing the upper limit, hearing damage is avoided.

The band sound pressure level can be measured using known methods, in particular using a third-octave band filter.

Preferably, the frequency range comprises at least one, particularly preferably all or a majority of the, essential frequency component(s) of the at least one sound. A significant frequency component is defined as a frequency component which has a sound pressure level above a limit of 45 decibels.

Alternatively, significant frequency components could be defined by a sound pressure level above a limit of 40 decibels and/or 50 decibels.

Therefore, at least a significant frequency component can lie in the described frequency range. Particularly preferably, all or a large part of the essential frequency components lie in the described frequency range.

The at least one sound may in particular have frequency components or significant frequency components outside the described frequency range, wherein preferably all or a large part of the significant frequency components lie within the claimed frequency range or sound pressure frequency range.

In particular, the lowest essential frequency component (fundamental tone or pitch of the at least one sound) is preferably arranged in the frequency range. It is conceivable that higher essential frequency components (overtones, especially higher overtones) are partly located outside the frequency range.

The pitch or the lowest essential frequency component of the at least one sound is preferably arranged in a frequency range of 1000 to 4000 hertz (comprising C6 to B7 in musical notation), preferably 1200 to 1800 hertz (comprising E6 to A6 in musical notation). The Anglo-American notation is used.

Preferably, the sound pressure level of the at least one sound is the sound pressure level at the location of the driver's car. The sound pressure level can be measured in particular by means of a sound pressure level meter or sound level meter at the driver's location.

The sound pressure level can also be referred to directly at the sound output device. For headphones or headsets, this corresponds, among other things, to the location of the driver's car. Preferably, the sound pressure level of the at least one sound means the sound pressure level of the entire sound, as can be measured, for example, with a microphone.

Alternatively, it is conceivable that the sound pressure level of the at least one sound refers to the sound pressure level of the, in particular essential, frequency components in the specified frequency range, which can be determined, for example, by a frequency-selective sound pressure level measurement, for example as described above by applying an FFT or other, in particular analog, methods known to a person skilled in the art.

Preferably, the evaluation unit is designed to detect a dangerous situation in the surroundings of the vehicle based on the at least one signal of the at least one surroundings sensor, wherein the sound output device outputs the at least one sound upon detection of the dangerous situation. It may happen that the playback of at least one sound in a dangerous situation is perceived by a driver but not recognized. An unrecognized sound can distract or confuse a driver in a dangerous situation.

According to the invention, the evaluation unit is designed to classify a dangerous situation in the surroundings of the vehicle based on the at least one signal of the at least one surroundings sensor at least into a first class, which requires a high degree of urgency of reaction from the driver, and into a second class, which requires a low degree of urgency of reaction from the driver. Furthermore, the evaluation unit is designed to cause the sound output device to output a first sound sequence comprising at least one sound when the reaction urgency is high and a second sound sequence different from the first sound sequence comprising at least one sound when the reaction urgency is low. The at least one sound can be designed as described above. A sound sequence is a temporal sequence of identical or different sounds.

Outputting different sound sequences depending on the urgency of the reaction leads to a quick reaction from the driver. This is due, among other things, to the fact that there is no habituation effect for the first sound sequence, since the first sound sequence is only output in very critical situations (and therefore rarely). In comparison, the second sound sequence can be output more frequently and alert the driver to less critical situations.

It can be estimated that the first sound sequence is output on average every 500 driving hours and the second sound sequence on average every 5 driving hours.

Depending on the urgency of the reaction, there are different requirements for the corresponding sound sequence. The first sound sequence, which is output when the reaction urgency is high, must result in a quick and targeted reaction even without knowledge of the urgency. The second sound sequence, which is output when the reaction urgency is low, can be learned by the driver because he hears it more often.

The first sound sequence should therefore be similar to the second sound sequence so that a driver executes the reaction learned with regard to the second sound sequence when perceiving the unknown first sound sequence. In particular, if the sound sequences have several different directional shapings for danger in the front region, in the left side region or in the right side region, a targeted learned reaction to the second sound sequence can be transferred to the unknown first sound sequence.

In particular, the pitch of at least one sound and/or the pitch difference of at least two sounds of the first sound sequence can be the same as the pitch of at least one sound or the pitch difference of at least two sounds of the second sound sequence. There is therefore a recognizable relationship between the first sound sequence and the second sound sequence.

The first sound sequence should also be different from the second sound sequence so that a driver understands the increased urgency of the reaction even without knowing the first sound sequence. Preferably, the first sound sequence should also convey the high urgency of the reaction, for example for psychoacoustic reasons.

This problem is addressed by the following examples.

In a preferred embodiment, the first sound sequence has a higher sound repetition rate than the second sound sequence. Additionally or alternatively, the first sound sequence can be output for a longer time (over a longer period of time) than the second sound sequence. The first sound sequence thus has at least one difference with respect to the second sound sequence so that a driver understands the increased urgency of the reaction even without knowing the first sound sequence. In addition, the first sound sequence itself (for psychoacoustic reasons) conveys the high urgency of the reaction, since the sound repetition rate is higher and the output duration is longer.

In particular, the first sound sequence may comprise sounds with a sound repetition rate of 7 to 15, preferably 7 to 10, sounds per second.

The sound repetition rate can be defined as the inverse of the duration between two consecutive output sounds. The sound repetition rate can also be defined as the average sound repetition rate taking into account pauses between successive sound sequences. Additionally or alternatively, the first sound sequence may comprise sounds with a sound duration between 40 and 50, preferably between 43 and 45, milliseconds. Additionally or alternatively, the first sound sequence may have a pause of 50 to 60, preferably 55 to 57 milliseconds after each sound.

Preferably, the evaluation unit is designed to cause the sound output device to repeatedly output the first sound sequence as long as the evaluation unit infers a high reaction urgency based on the signals of the at least one surroundings sensor. It may be provided that between every second repetition of the first sound sequence there is an intermediate pause with a duration of 100 to 500 milliseconds, preferably 250 to 350 milliseconds.

Embodiments of the properties of the second sound sequence (for a low reaction urgency) are given below:
In particular, the second sound sequence may comprise sounds with a sound repetition rate of 5 to 8, preferably 5.3 to 5.4, sounds per second.

Additionally or alternatively, the second sound sequence may comprise sounds with a duration between 80 and 90, preferably between 84 and 86, milliseconds.

Additionally or alternatively, the second sound sequence may have a respective pause of 75 to 107, preferably 101 to 103, milliseconds after each sound.

The sounds of the second sound sequence may have reverberation. The duration of the sound and the subsequent pause are defined without taking reverberation into account.

Preferably, the evaluation unit is designed to cause the sound output device to repeatedly output the second sound sequence only once, as soon as the evaluation unit infers a low reaction urgency based on the signals of the at least one surroundings sensor. The second sound sequence can also be output a few times, but preferably not continuously.

By outputting the second tone sequence only once/few times and the lower sound repetition rate, the driver is given a sense of urgency to react without being unduly distracted or confused. In addition, there is no habituation effect, since the first sound sequence stands out from the second sound sequence.

Due to the high sound repetition rate and the continuous output, the first sound sequence conveys both relative to the second sound sequence and in itself that there is a high urgency to react.

When the vehicle approaches an object, the hazardous situation can first be classified as one requiring low reaction urgency and consequently the second sound sequence can be output. If the vehicle continues to approach the object, the dangerous situation can then be classified as one requiring a high level of urgency of reaction and the first sound sequence can be output.

However, a dangerous situation can also immediately be classified as requiring a high level of urgency of reaction, so that the first sound sequence is output immediately. This can happen, for example, if a dangerous situation suddenly occurs.

In a preferred embodiment, the first sound sequence and the second sound sequence can each have different directional shapings, depending on whether the evaluation unit concludes, based on the signals of the at least one surroundings sensor, that there is a danger in the front region or in the left side region or in the right side region or in the rear region of the vehicle. This allows a driver to react to a dangerous situation in a targeted manner.

It can also output its own direction shaping if the evaluation unit detects a change in status on the vehicle's dashboard. A sound sequence of this directional shaping is intended to entice a driver to look at the dashboard and notice the change that is typically accompanied by the illumination of a warning light. Such a status change could be, for example, switching to the reserve tank or an indication of ice danger.

Preferably, the pitch of at least one sound of the first sound sequence with a directional shaping is equal to the pitch of at least one sound of the second sound sequence with the same directional shaping. In particular, multiple sounds of the first sound sequence can have sounds in the second sound sequence that correspond in pitch. A difference in pitch, especially a musical interval, of the first sound sequence can also be represented in the second sound sequence.

Thus, the first sound sequence and the second sound sequence of a certain directional shaping are related to each other. In particular, differences in pitch and musical intervals are easily recognizable. A driver can thus recognize the directional shaping of an unknown first sound sequence based on its similarity to the known second sound sequence of the same directional shaping. This allows him to react in a targeted manner when the urgency of the reaction is high.

Specific directional shapings of the sound sequences can be provided for a danger in the front region, the left side region and/or the right side region. A hazard behind the vehicle or a change in status on the dashboard can also cause a corresponding direction shaping. Examples of directional shapings are given below.

In one embodiment, the evaluation unit is designed to cause the sound output device to output the first sound sequence and/or the second sound sequence with sounds that ascend in pitch when the evaluation unit concludes that there is a danger in the front region of the vehicle based on the signals from the at least one surroundings sensor. The rising sounds guide a driver to look forward due to psychoacoustic effects. This alerts a driver to a danger in a targeted manner. In addition, the ascending sounds have a recognition value. A driver can therefore transfer the reaction to the known ascending second sound sequence (looking forward) to the unknown ascending first sound sequence.

In particular, the first sound sequence can comprise three sounds with different pitches, with the pitches preferably being around 1319 hertz (E6), 1480 hertz (F♯6) and 1568 hertz (G6). The first sound sequence can have a pitch difference of a whole tone and a pitch difference of a semitone. In particular, the second sound sequence can comprise two sounds with different pitches, with the pitches preferably being around 1480 hertz (F♯6) and 1568 hertz (G6). The second sound sequence can have a pitch difference of a semitone.

The pitches of the first sound sequence and the second sound sequence correspond to each other at least partially. Both have at least partially the same pitch and have a common pitch difference (semitone interval). This allows a driver to recognize the relationship between the two sound sequences.

The use of three pitches in the first sound sequence suggests a higher urgency of reaction than the use of two pitches.

In one embodiment, the sound output device has a left and a right channel, wherein the evaluation unit is designed to cause the sound output device to output the first sound sequence and/or the second sound sequence mainly on the left or on the right channel if the evaluation unit concludes, based on the signals of the at least one surroundings sensor, that there is a danger in the left side region or in the right side region of the vehicle.

The left or right channel is preferably perceived mainly or exclusively by the driver's left or right ear, for example through stereo headphones. This allows targeted attention to be drawn to a dangerous situation.

Preferably, the first sound sequence and the second sound sequence of this directional configuration may comprise sounds with a constant pitch. The indication of a danger in the side region is therefore made exclusively by the arrangement of the sound sequence in the stereo field. This avoids confusion with the “front” direction configuration.

In a preferred embodiment, the at least one surroundings sensor is a camera, a distance measuring device and/or a communication device for communication with other vehicles or stationary devices.

The camera can be a visible light or infrared camera. A camera can detect a dangerous situation using known methods. The distance measuring device can work with radar, sonar or lidar waves, for example. However, other distance measuring devices are also possible.

A communication device for communication with other vehicles or stationary facilities can consist of a wireless connection, for example via microwaves. For example, a convoy of vehicles may connect with each other so that abrupt braking by a leading vehicle causes at least one sound or sound sequence to be output by the following vehicle.

The sound output device can be a helmet speaker, a headset or a speaker mounted on the vehicle. Preferably, the at least one sound can be transmitted wirelessly to the sound output device, in particular from a sound generating device or from the evaluation unit. In particular, a known transmission protocol can be used for this purpose. However, connections via cable are also conceivable, especially if the loudspeaker is located on the vehicle.

In a preferred embodiment, audio data of the at least one sound or the at least one sound sequence are stored on a, preferably digital, data carrier, in particular in a time-and value-discrete representation. However, analog data carriers with a continuous display of the audio data are also conceivable. The data carrier can be located on the vehicle or in another location, for example in the driver's helmet.

In particular, eight sound sequences can be stored on the data carrier: two sound sequences for a dangerous situation in the front region, two sound sequences for a dangerous situation in the left side region, two sound sequences for a dangerous situation in the right side region, two sound sequences for a dangerous situation in the rear region or for a status change on the dashboard (the latter optional). A first sound sequence can be respectively provided for a high reaction urgency and a second sound sequence for a low reaction urgency.

Optionally, only four sound sequences can be stored on the data carrier: two sound sequences for a dangerous situation in the front region (a first sound sequence and a second sound sequence, depending on the urgency of the reaction), one sound sequence for a dangerous situation in the left side region and one sound sequence for a dangerous situation in the right side region. It can therefore be provided that a distinction is made between the different reaction urgency levels only in the event of a dangerous situation in the front region.

The evaluation unit can be designed to directly cause the sound output device to output at least one sound. In this case, the evaluation unit may comprise a sound generating device. A sound generating device generates the sound signal, which the sound output device converts into a physical sound.

The sound generating device may alternatively be a stand-alone unit or may be housed in another unit, such as a central processing unit of the vehicle or the sound output device. The evaluation unit can be designed to indirectly cause the sound output device to output at least one sound.

The sound generating device may be a reader for reading audio data from a digital or analog data carrier and a converter for converting the audio data into an electrical signal for driving the loudspeakers. Alternatively, the sound generating device may be an analog or digital synthesizer that generates the sound without reading it from a memory.

The evaluation unit can be a control unit of the vehicle, which also performs other tasks. However, the evaluation unit can also be arranged on the vehicle only for the described function.

The open vehicle is preferably a motor-driven vehicle, in particular a motorcycle, a quad, a buggy or a convertible. In motor-driven, open vehicles, the wind is particularly loud due to the high speeds.

According to the invention, a computer program product is also provided for warning a driver of an open vehicle, comprising commands which, when the program is executed by an evaluation unit, cause the evaluation unit:
to receive signals from at least one surroundings sensor, and
to send or have sent at least one sound to a sound output device to warn the driver, wherein the at least one sound has at least one frequency component in a frequency range of 900 to 20000, in particular 1000 to 10000, hertz.

Preferably, the at least one sound has a sound pressure level, wherein the sound pressure level lies in a range of 50 to 110 decibels, preferably wherein at least one, particularly preferably all or a majority of the frequency component(s) and the sound pressure level of the at least one sound are arranged within an imaginary region in a sound pressure level-frequency coordinate system, wherein the imaginary region is a triangle with:
a first corner point at 90 decibels and 900 hertz, and
a second corner point at 90 decibels and 20000 hertz, and
a third corner point at 50 decibels and 5000 hertz.

A computer program product according to the invention comprises commands, which, when the program is executed by an evaluation unit, cause the evaluation unit
to receive signals from at least one surroundings sensor,
to classify a dangerous situation in the surroundings of the vehicle based on the at least one signal of the at least one surroundings sensor at least into a first class, which requires a high degree of urgency of reaction from the driver, and into a second class, which requires a low degree of urgency of reaction from the driver,
in the case of a high reaction urgency, to send or have sent at least a first sound sequence comprising at least one sound to a sound output device,
in the case of a low reaction urgency, to send or have sent at least one second sound sequence different from the first sound sequence comprising at least one sound to a sound output device.

### BRIEF DESCRIPTION OF THE DRAWINGS

Further embodiments and details will be described below with reference to the drawings, in which:

FIG. 1a is a sound pressure level-frequency diagram with the volume of the wind, the hearing damage limit and the perception limit for older people,

FIG. 1b is a sound pressure level-frequency diagram as in FIG. 1a with a limited imaginary region for the sound pressure and the frequency of the sound,

FIG. 2 is a sound pressure level-frequency diagram as in FIG. 1b with perception limit for earplug-wearing drivers and maximum volume of a tested sound output device,

FIG. 3 is a sound pressure level-frequency diagram with the frequency spectrum of a sound sequence,

FIG. 4 shows band sound pressure level ranges of different third octave bands and band sound pressure levels of a sound sequence,

FIG. 5a shows a waveform of an embodiment of the first sound sequence,

FIG. 5b shows the notation of an embodiment of the first sound sequence,

FIG. 6a shows a waveform of an embodiment of the second sound sequence,

FIG. 6b shows the notation of an embodiment of the second sound sequence,

FIG. 7 shows regions around the vehicle perceived by the surroundings sensor, and

FIG. 8 shows the vehicle with driver and warning system.

### DETAILED DESCRIPTION OF THE INVENTION

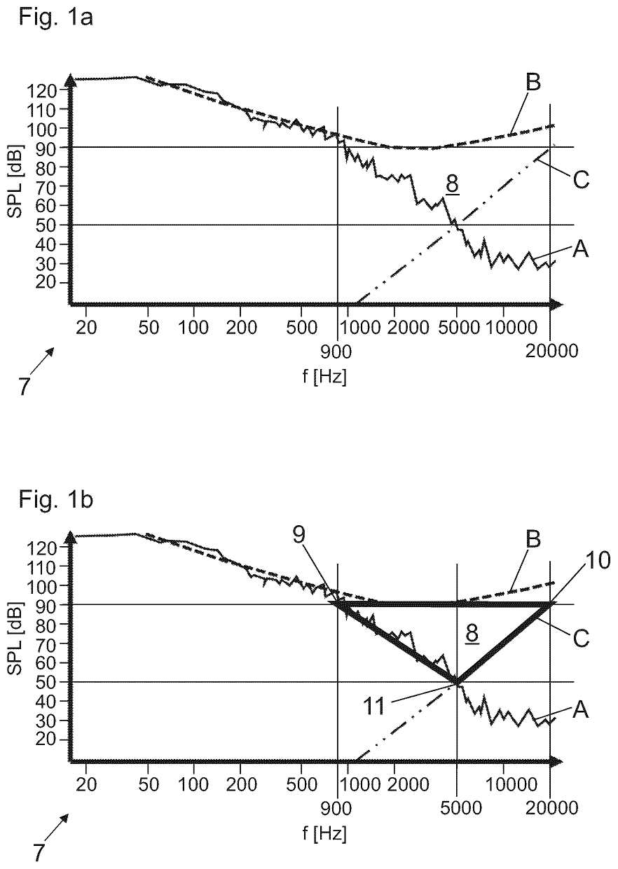

FIG. 1a shows a sound pressure level-frequency diagram with a sound pressure level-frequency coordinate system 7. On the abscissa, the frequency in hertz is plotted logarithmically in the audible range. The sound pressure level in decibels is plotted on the ordinate. The sound pressure level values were determined using a Fast Fourier Transform (FFT) with a resolution (“FFT size”) of 4096 bins in the frequency range from 20 to 20000 Hz. The “peak hold” value of the sound pressure level is indicated, i.e. the peak value of the sound pressure level at any given time (without averaging over time).

In the coordinate system 7, the frequency-dependent sound pressure level of the wind A is plotted as a continuous line, the hearing damage limit B as a dashed line and the perception limit for older people C as a dash-dotted line (with two points).

The sound pressure level of the wind was determined by tests. For this purpose, a microphone was mounted in a helmet to measure the sound pressure level at the driver's car.

In a wind tunnel, various air speeds ranging from 30 to 140 kilometers per hour were set and analyzed. Riders were placed in a wind tunnel wearing different types of helmets (full-face helmet or flip-up helmet with raised or lowered chin guard, shell helmet with visor or with goggles). The driver's head was placed in different positions for all air speeds (look to the left, look straight, look to the right, look over the shoulder left, look over the shoulder right). The body positions were also varied (upright, leaning forward).

In addition, the sound pressure level of the wind on the road was measured for different scenarios (country road, motorway, city streets, tunnels), with the test vehicles being motorcycles and used with or without a windshield.

The sound pressure level was measured in each case and its frequency dependence was analyzed. The results are plotted as volume A.

The sound pressure level of the wind A decreases with higher frequencies. A sound 5 to warn the driver should therefore have frequency components in the higher frequency range. In addition, a sound 5 should not be too loud so that the hearing is not (permanently) damaged (below line B).

Depending on at least one signal from the at least one surroundings sensor 2, the evaluation unit 3 can cause a sound output device 4 to output at least one sound 5 to warn the driver 6 of the vehicle, wherein the at least one sound 5 has at least one or all or a majority of the frequency component(s) in a frequency range of 900 to 20000 hertz. This frequency range is shown in FIG. 1a.

The at least one sound has a sound pressure level, wherein the sound pressure level is preferably in a range of 50 to 90 decibels. These values are also shown in FIG. 1a.

This sound pressure level-frequency range corresponds to a rectangular, imaginary region 8 in the sound pressure level-frequency coordinate system 7. The range is located below the limit for hearing damage B, so that (permanent) hearing damage is avoided. In addition, the region is located at such high frequencies that the volume of the wind A has already decreased somewhat. Normally, such a sound 5 can be easily perceived while driving.

FIG. 1b shows the sound pressure level-frequency coordinate system 7 from FIG. 1a. In addition, a restricted, improved imaginary region 8 is shown in the sound pressure level-frequency coordinate system 7. The imaginary region 8 is a triangle with a first corner point 9 at 90 decibels and 900 hertz, a second corner point 10 at 90 decibels and 20000 hertz, and a third corner point 11 at 50 decibels and 5000 hertz.

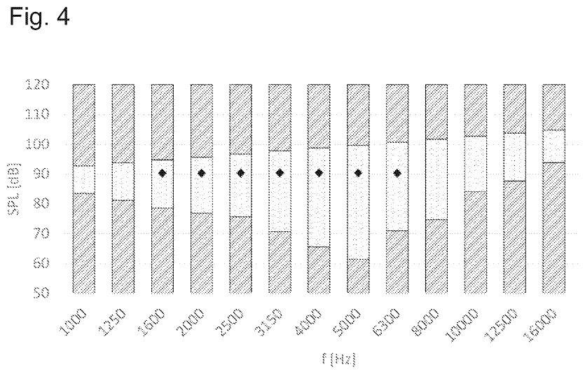

Sounds 5 with frequency components and a sound pressure level in this restricted region 8 are, on the one hand, more audible for older people, since the region 8 is completely above the perception limit C for older people. On the other hand, the region 8 lies completely above the volume of the wind A, so that a sound 5 with sound pressure level and frequency components in this region 8 is more audible. Overall, a sound 5 with sound pressure level and frequency components within the region 8 of FIG. 1b is clearly audible for all people and in all driving situations. It should be noted again that the region is determined for the peak hold sound pressure level, which was calculated using an FFT with a resolution of 4096 bins. The region can take other values, for example the value of the sound pressure level a band sound pressure level, in particular of a third octave band (as in FIG. 4).

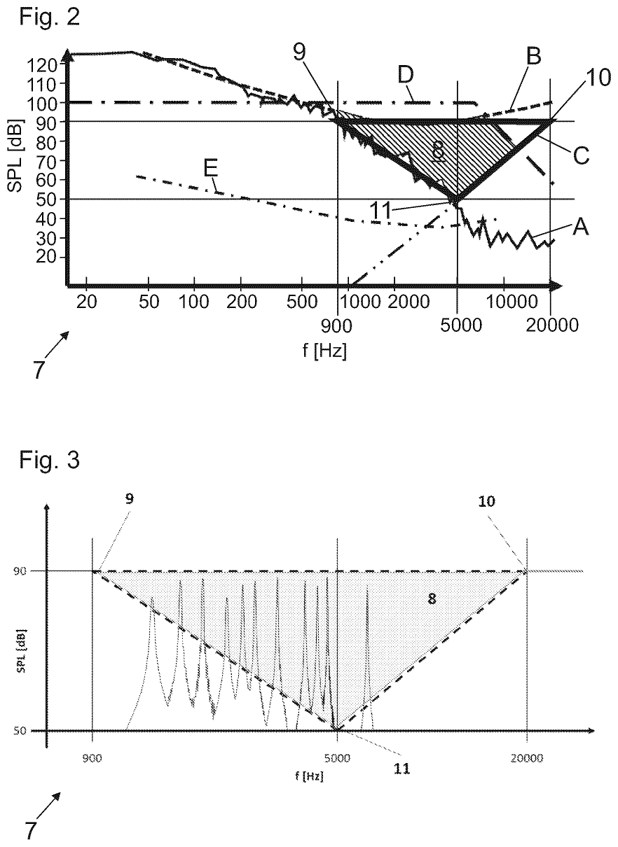

FIG. 2 shows the sound pressure level-frequency coordinate system 7 from FIGS. 1a and 1b with two additional lines D and E.

On the one hand, the perception limit E for drivers with earplugs is shown as a thin, dashed line. Sound pressure levels above this perception limit E are clearly audible even with earplugs. This perception limit E does not intersect the imaginary region 8 in the sound pressure level-frequency coordinate system 7 of the sound 5, so it is not considered further.

On the other hand, the maximum sound pressure level D of a tested sound output device 4 is shown as a thick dash-dotted line. The tested sound output device 4 is a typical helmet intercom system which can be controlled wirelessly. Other sound output devices 4 were also tested and produced similar results. Preferably, the frequency components and the sound pressure level of a sound 5 are arranged below the line of the maximum sound pressure level D of the tested sound device 4 (shaded region), especially since the sound 5 can be unpleasant at higher frequencies and requires other technical means. However, it is conceivable to provide a sound 5 using a suitable sound output device 4 above this line, since this limitation does not describe a perceptibility or harmfulness of the sound 5, but merely the technical limitation of a typical system.

FIG. 3 shows a sound pressure level-frequency diagram with the frequency spectrum of a sound sequence. In particular, the imaginary region 8 is shown in the sound pressure level-frequency coordinate system 7 of FIGS. 1b and 2.

The frequency spectrum of the sound sequence, as well as the lines in FIGS. 1a, 1b and 2, was generated using an FFT with a resolution of 4096 bins on a frequency range of 20 to 20000 Hz. These are “peak hold” values of the sound pressure level (without time averaging).

The peaks of the frequency spectrum of the at least one sound 5, and thus its (essential) frequency components, are all located in the imaginary region 8.

The sound sequence shown is in particular the first sound sequence 15, in particular the one for a high reaction urgency in the front region of the vehicle. The sound sequence 15 consists of three sounds 5, each of which also has peaks in the imaginary region 8.

FIG. 4 shows band sound pressure level ranges of different third-octave bands and band sound pressure levels of a sound sequence, in particular the first sound sequence 15 as in FIG. 3.

The center frequencies of the respective third-octave bands are plotted on the abscissa and the band sound pressure level on the ordinate.

The bright band sound pressure level regions represent the permitted band sound pressure level range for the respective third-octave band. The black diamond shows the band sound pressure levels of the first sound sequence 15.

The first sound sequence 15 has significant frequency components in the third octave bands with center frequencies 1600, 2000, 2500, 3150, 4000, 5000 and 6300. The band sound pressure level in these third-octave bands is approximately 90.3 decibels. This value is larger than the peak values in FIG. 3, which are all below 90 decibels, since they refer to other, particularly larger, frequency ranges (FIG. 4: third-octave bands, FIG. 3: 4096 bins of the FFT).

The maximum band sound pressure level (so that no hearing damage occurs) and the minimum band sound pressure level (so that the sounds 5 are audible despite driving noise and age-related hearing) can be found in the following table:

| Center frequency | Minimum band | Maximum band |
|---|---|---|
| of the third-octave | sound pressure | sound pressure |
| band in hertz | level in decibels | level in decibels |
| 1000 | 87.0 | 92.7 |
| 1250 | 83.4 | 93.7 |
| 1600 | 81.1 | 94.7 |
| 2000 | 78.6 | 95.6 |
| 2500 | 76.9 | 96.6 |
| 3150 | 75.6 | 97.7 |
| 4000 | 70.7 | 98.7 |
| 5000 | 65.5 | 99.7 |
| 6300 | 61.4 | 100.7 |
| 8000 | 70.9 | 101.7 |
| 10000 | 74.7 | 102.7 |
| 12500 | 84.0 | 103.7 |
| 16000 | 87.7 | 104.7 |

The sound output device 4 can output a sound sequence 15, 16 comprising at least one sound 5. The sound sequence 15, 16 can be selected depending on the type of dangerous situation. In particular, the dangerous situation in the surroundings of the vehicle 1 can be classified by the evaluation unit 3 at least into the classes “low reaction urgency” and “high reaction urgency” based 5 on the at least one signal of the at least one surroundings sensor 2.

If the reaction urgency is high, a first sound sequence 15 is output and if the reaction urgency is low, a second sound sequence 16 different from the first sound sequence is output.

In addition, depending on the direction of the danger region relative to the vehicle 1, the first sound sequence 15 and the second sound sequence 16 can be varied (different directional shapings).

A preferred embodiment of the most important sound sequences 15, 16 is given below:

| Direction of the | High reaction urgency -> | Low reaction urgency -> |
|---|---|---|
| danger region | first sound sequence 15 | second sound sequence 16 |
| Front | three sounds 5 with different, | two sounds 5 with different, |
| region 21 | ascending pitches | ascending pitches |
| | centered in the stereo field | centered in the stereo field |
| | higher sound repetition rate | lower sound repetition rate |
| | continuously delivered until the | delivered once when dangerous |
| | dangerous situation is over | situation is detected |
| Left side | sounds 5 with constant pitch | sounds 5 with constant pitch |
| region 22 | left in the stereo field | left in the stereo field |
| | higher sound repetition rate | lower sound repetition rate |
| | continuously delivered until the | delivered once when dangerous |
| | dangerous situation is over | situation is detected |
| Right side | sounds 5 with constant pitch | sounds 5 with constant pitch |
| region 23 | right in the stereo field | right in the stereo field |
| | higher sound repetition rate | lower sound repetition rate |
| | continuously delivered until the | delivered once when dangerous |
| | dangerous situation is over | situation is detected |

In addition, directional shapings can also be provided for a dangerous situation in the rear region and a status change on the dashboard.

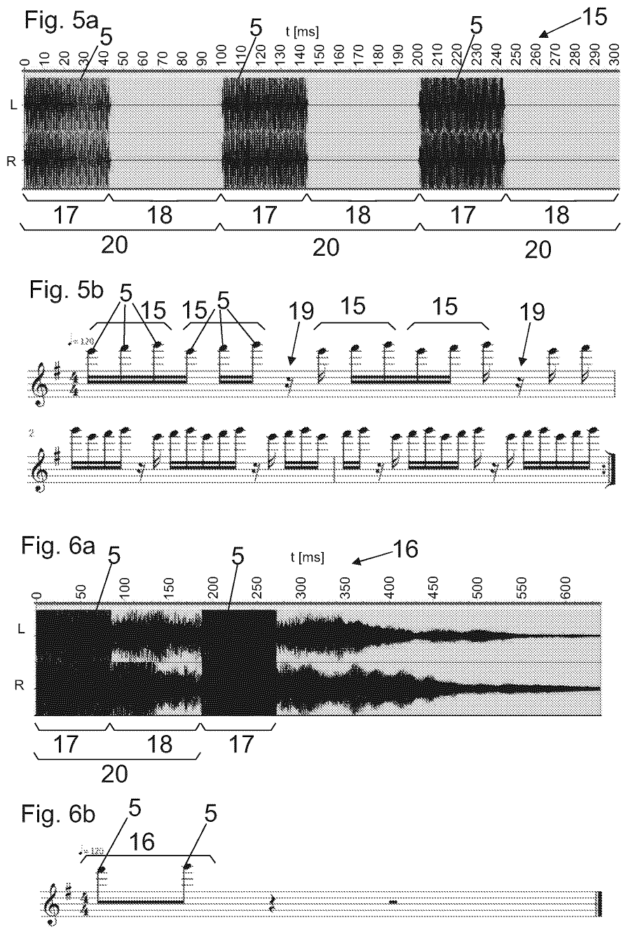

FIGS. 5a and 5b show properties of an embodiment of a first sound sequence 15. In particular, this is a sound sequence 15 with a directional shaping that is intended to indicate a dangerous situation in the front region of the vehicle 1.

FIG. 5a shows the waveform of the first sound sequence 15 on the left channel L and the right channel R. This is the directional shaping for a dangerous situation in the front region 21 of the vehicle 1, the sounds 5 are arranged centrally in the stereo field.

The sounds 5 have a sound repetition rate of approximately 10 sounds 5 per second. The sound repetition period 20 is approximately 100 milliseconds. The sound repetition rate 20 is defined here as the repetition rate between two adjacent sounds 5 within the first sound sequence 15 (without taking into account intermediate pauses 19), as the inverse of the sound repetition period 20. The sound repetition period 20 is the duration between two sound start times.

An average sound repetition rate including the intermediate pause 19 is somewhat smaller (6.7 sounds per second).

The sounds 5 of the first sound sequence 15 have a sound duration 17 between 40 and 50, preferably between 43 and 45, milliseconds. After sounds 5, a respective pause 18 of 50 to 60, preferably 55 to 57 milliseconds is provided.

FIG. 5b shows the notation of several successive first sound sequences 15 in the directional shaping for a dangerous situation in the front region 21 of the vehicle 1. In particular, the pitches of the sounds 5 are noted. In this embodiment, the sound sequence 15 has the pitches E6 (1318.51 Hz˜1319 Hz), F♯6 (1479.98 Hz˜1480 Hz) and G6 (1567.98 Hz˜1568 Hz).

It can also be seen that after two sound sequences 15 there is an intermediate pause 19, after which two more sound sequences 15 followed by an intermediate pause 19 are output, and so on.

The rising pitches cause a driver to look forward, which is desirable in a dangerous situation in the front region 21. The pitches are also similar to the second sound sequence 16, which is shown below.

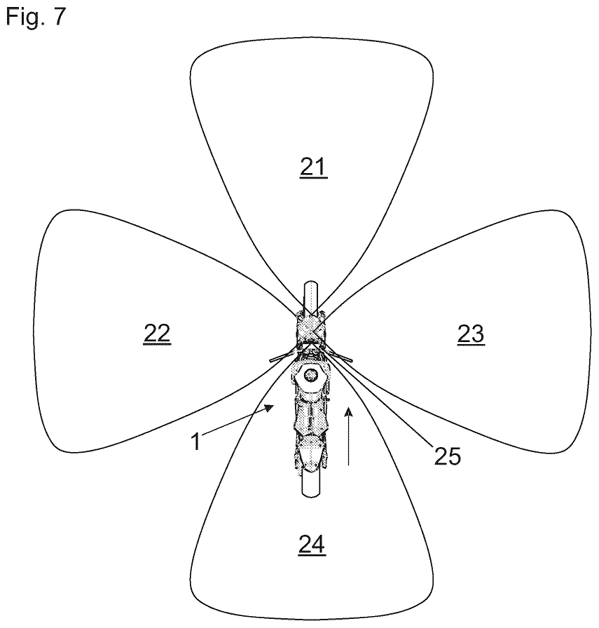

FIG. 6a shows the waveform of the second sound sequence 16 on the left channel L and the right channel R. This is the directional shaping for a dangerous situation in the front region 21 of the vehicle 1, the sounds 5 are arranged substantially centrally in the stereo field.

The sounds 5 of the second sound sequence 16 have a sound repetition rate of 5 to 6, preferably 5.3 to 5.4, sounds 5 per second. This corresponds to a sound repetition period 20 of approximately 187 milliseconds. The sound repetition rate is therefore higher than in the first sound sequence 15, which means that the first sound sequence 15 signals a higher reaction urgency than the second sound sequence 16.

The sounds 5 of the second sound sequence 16 have a sound duration 17 between 80 and 90, preferably between 84 and 86, milliseconds.

After the sounds 5 of the second sound sequence 16 there is a pause 18 of 97 to 107, preferably 101 to 103, milliseconds. In this case there is only one pause 18, since the sound sequence 16 consists of only two sounds 5 and is played only once.

It is also evident from FIG. 6a that the sounds 5 have a reverberation. The sound duration and pauses are given without taking reverberation into account.

FIG. 6b shows the notation of the second sound sequences 16 in the directional shaping for a dangerous situation in the front region 21 of the vehicle 1. In particular, the pitches of the sounds 5 are noted. In this embodiment, the sound sequence 15 has the sequence of pitches F♯6 (1479.98 Hz˜1480 Hz) and G6 (1567.98 Hz˜1568 Hz), i.e. a semitone step.

These tones are also included in the first sound sequence 15. A driver can therefore get used to the more frequently sounding second sound sequence 16 for dangerous situations with a low reaction urgency. For example, he can learn to look forward. Due to the similarity to the first sound sequence (two equal pitches, one equal semitone interval), a driver can quickly execute this learned reaction even in a dangerous situation with high reaction urgency.

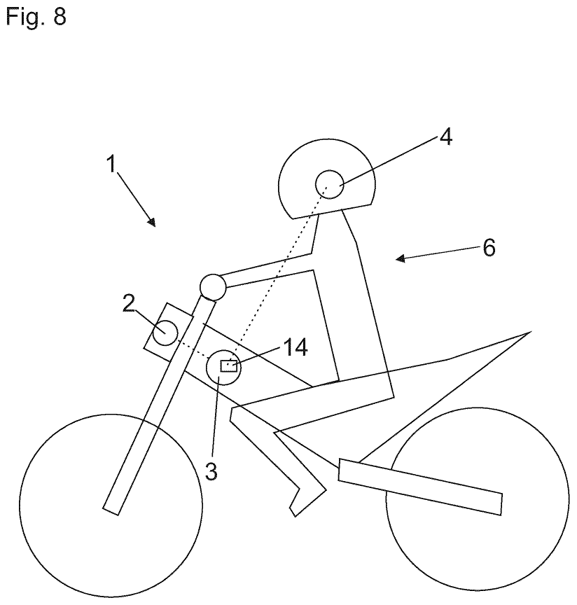

FIG. 7 shows the regions around the vehicle 1 perceived by the surroundings sensor 2 (see FIG. 8). In particular, a distinction is made between a front region 21, a left side region 22, a right side region 23 and a rear region 24.

The first sound sequence 15 and the second sound sequence 16 each have different directional shapings, depending on whether the evaluation unit 3 infers, based on the signals of the at least one surroundings sensor 2, that there is a danger in the front region 21 or in the left side region 22 or in the right side region 23 or in the rear region 24 of the vehicle 1.

The sound sequences 15, 16 described in FIGS. 5a to 6b are suitable for the directional shaping of a dangerous situation in the front region 22.

In the side regions 22, 23 the sound sequences can be played mainly on the left channel L or the right channel R. The pitch can be constant. Otherwise, the same sound repetition rates 20, sound durations 17 and pauses 18, 19 can be provided for the first sound sequence and the second sound sequence, respectively.

When information is first displayed on the dashboard, for example when an empty main tank or ice danger is detected, sound sequences with descending tone sequences can be used. A driver is then forced into looking down at the dashboard.

FIG. 8 shows an open vehicle 1 in the form of a motorcycle with a driver 6. A sound output device 4, for example a headset, is arranged in the helmet of the driver 6. An evaluation unit 3 interprets signals from a surroundings sensor 2 to classify a dangerous situation. In particular, the reaction urgency (low, high) and the location of the dangerous situation are classified (front region 21, left side region 22, right side region 23, rear region 24, status change on the dashboard 25). Depending on the classification, the evaluation unit 3 causes the sound output device 4 to play a first sound sequence 15 or a second sound sequence 16 or a sound 5. The sound sequence 15, 16 can be generated by a sound generating device 14, which reads the sound sequence 15, 16 from a data carrier (not shown). The sound generating device 14 is arranged in the evaluation unit 3 in FIG. 8, but it can also be arranged elsewhere on the vehicle 1 or on the helmet.

### LIST OF REFERENCE NUMERALS

1 open vehicle
2 surroundings sensor
3 evaluation unit
4 sound output device
5 sound
6 driver
7 sound pressure level-frequency coordinate system
8 imaginary region in the sound pressure level-frequency coordinate system
9 first corner point
10 second corner point
11 third corner point
12 significant frequency component
13 maximum sound pressure level
14 sound generating device
15 first sound sequence
16 second sound sequence
17 sound duration
18 pauses
19 intermediate pause
20 sound repetition period
21 front region
22 left side region
23 right side region
24 rear region
25 dashboard
L left channel
R right channel
A volume of the wind
B hearing damage limit
C perception limit of older people
D maximum volume of a tested sound output device
E perception limit with earplugs

1. An open vehicle comprising:
at least one surroundings sensor, and
an evaluation unit,
wherein the evaluation unit is configured to cause a sound output device to output at least one sound for warning the driver of the vehicle depending on at least one signal from the at least one surroundings sensor, and
wherein the at least one sound has at least one frequency component in a frequency range from 900 to 20000, in particular 1000 to 10000, hertz.

2. The open vehicle according to claim 1, wherein the at least one sound has a sound pressure level, the sound pressure level being in a range of 50 to 110 decibels.

3. The open vehicle according to claim 1, wherein at least one, preferably all or a majority of the frequency component(s) and the sound pressure levels of the at least one sound are arranged within an imaginary region in a sound pressure level-frequency coordinate system, wherein the imaginary region is a triangle with:
a first corner point at 90 decibels and 900 hertz, and
a second corner point at 90 decibels and 20000 hertz, and
a third corner point at 50 decibels and 5000 hertz.

4. The open vehicle according to claim 1, wherein the band sound pressure level of a third-octave band of the at least one sound with a center frequency located in the frequency range is in a range of 50 to 105 decibels, in particular wherein the band sound pressure level of a third-octave band of the at least one sound with a center frequency:
of 1000 hertz is a band sound pressure level in a range of 87.0 to 92.7 decibels, and/or
of 1250 hertz is a band sound pressure level in a range of 83.4 to 93.7 decibels, and/or
of 1600 hertz is a band sound pressure level in a range of 81.1 to 94.7 decibels, and/or
of 2000 hertz is a band sound pressure level in a range of 78.6 to 95.6 decibels, and/or
of 2500 hertz is a band sound pressure level in a range of 76.9 to 96.6 decibels, and/or
of 3150 hertz is a band sound pressure level in a range of 75.6 to 97.7 decibels, and/or
of 4000 hertz is a band sound pressure level in a range of 70.7 to 98.7 decibels, and/or
of 5000 hertz is a band sound pressure level in a range of 65.5 to 99.7 decibels, and/or
of 6300 hertz is a band sound pressure level in a range of 61.4 to 100.7 decibels, and/or
of 8000 hertz is a band sound pressure level in a range of 70.9 to 101.7 decibels, and/or
of 10000 hertz is a band sound pressure level in a range of 74.7 to 102.7 decibels, and/or
of 12500 hertz is a band sound pressure level in a range of 84.0 bis 103.7 decibels, and/or
of 16000 hertz is a band sound pressure level in a range of 87.7 to 104.7 decibels.

5. The open vehicle according to claim 1, wherein the evaluation unit is designed to detect a dangerous situation in the surroundings of the vehicle based on the at least one signal of the at least one surroundings sensor, wherein the sound output device outputs the at least one sound upon detection of the dangerous situation.

6. The open vehicle with at least one surroundings sensor and an evaluation unit, in particular according to claim 1, wherein the evaluation unit is designed to classify a dangerous situation in the surroundings of the vehicle based on the at least one signal of the at least one surroundings sensor at least into a first class, which requires a high reaction urgency of the driver, and into a second class, which requires a low reaction urgency of the driver, wherein the evaluation unit is designed to cause the sound output device to output a first sound sequence comprising at least one sound in the case of a high reaction urgency and a second sound sequence comprising at least one sound which is different from the first sound sequence in the case of a low reaction urgency.

7. The open vehicle according to claim 6, wherein the pitch of at least one sound and/or the pitch difference of at least two sounds of the first sound sequence is the same as the pitch of at least one sound or the pitch difference of at least two sounds of the second sound sequence.

8. The open vehicle according to claim 6, wherein the first sound sequence has a greater sound repetition rate than the second sound sequence and/or wherein the first sound sequence is output for a longer time than the second sound sequence.

9. The open vehicle according to claim 6, wherein the first sound sequence has:
sounds with a sound repetition rate of 7 to 15, preferably 7 to 10, sounds per second, and/or sounds with a sound duration between 40 and 50, preferably between 43 and 45, milliseconds, and/or
a pause of 50 to 60, preferably 55 to 57 milliseconds after the sounds.

10. The open vehicle according to claim 6, wherein the evaluation unit is configured to cause the sound output device to repeatedly output the first sound sequence as long as the evaluation unit infers a high reaction urgency based on the signals of the at least one surroundings sensor, preferably wherein between every second repetition of the first sound sequence there is an intermediate pause with a duration of 100 to 500 milliseconds, preferably 250 to 350 milliseconds.

11. The open vehicle according to claim 6, wherein the second sound sequence has:
sounds with a sound repetition rate of 5 to 8, preferably 5.3 to 5.4, sounds per second, and/or
sounds with a sound duration between 80 and 90, preferably between 84 and 86, milliseconds, and/or
after the sounds a respective pause (18) of 75 to 107, preferably 101 to 103, milliseconds.

12. The open vehicle according to claim 6, wherein the evaluation unit is configured to cause the sound output device to output the second sound sequence only once as soon as the evaluation unit infers a low reaction urgency based on the signals of the at least one surroundings sensor.

13. The open vehicle according to claim 6, wherein the first sound sequence and the second sound sequence each have different directional shapings, depending on whether the evaluation unit infers, on the basis of the signals from the at least one surroundings sensor, that there is a danger in the front region or in the left side region or in the right side region or in the rear region of the vehicle or depending on whether the evaluation unit detects a change in a status on the dashboard of the vehicle.

14. The open vehicle according to claim 13, wherein the pitch of at least one sound or the pitch difference of at least two sounds of the first sound sequence with a directional shaping is the same as the pitch of at least one sound or the pitch difference of at least two sounds of the second sound sequence with the same directional shaping.

15. The open vehicle according to claim 6, wherein the evaluation unit is configured to cause the sound output device to output the first sound sequence and/or the second sound sequence with sounds that ascend in pitch when the evaluation unit infers that there is a danger in the front region of the vehicle based on the signals from the at least one surroundings sensor.

16. The open vehicle according to claim 6, wherein:
the first sound sequence comprises three sounds with different pitches, preferably with the pitches being around 1319 hertz, 1480 hertz and 1568 hertz, and/or
the first sound sequence can have a pitch difference of a whole tone and a pitch difference of a semitone, and/or
the second sound sequence can comprise two sounds with different pitches, preferably wherein the pitches are around 1480 hertz and 1568 hertz, and/or
the second sound sequence has a pitch difference of a semitone.

17. The open vehicle according to claim 6, wherein the sound output device has a left channel and a right channel, wherein the evaluation unit is designed to cause the sound output device to output the first sound sequence and/or the second sound sequence mainly on the left channel or on the right channel if the evaluation unit infers, on the basis of the signals from the at least one surroundings sensor, that there is a danger in the left side region or in the right side region of the vehicle, preferably wherein the first sound sequence and the second sound sequence comprise sounds with a constant pitch.

18. The open vehicle according to claim 1, wherein the at least one surroundings sensor is a camera, a distance measuring device, in particular a lidar system, and/or a communication device for communication with other vehicles or stationary devices.

19. The open vehicle according to claim 1, wherein the sound output device is a helmet loudspeaker, a headset or a loudspeaker arranged on the vehicle, preferably wherein the at least one sound can be sent wirelessly to the sound output device, in particular from a sound generation device or from the evaluation unit.

20. The open vehicle according to claim 1, wherein audio data of the at least one sound or of the at least one first and second sound sequence are stored on a, preferably digital, data carrier, in particular in a time-and value-discrete representation, particularly preferably wherein the data carrier is arranged on the vehicle.

21. The open vehicle according to claim 1, wherein the vehicle is a motor-driven vehicle, in particular a motorcycle, a quad, a buggy or a convertible.

22. A computer program product for warning a driver of the open vehicle according to claim 1, comprising commands which, when the program is executed by an evaluation unit, cause the evaluation unit:
to receive signals from at least one surroundings sensor,
to send or have sent at least one sound to a sound output device to warn the driver, wherein
the at least one sound has at least one frequency component in a frequency range of 900 to 20000, in particular 1000 to 10000, hertz.

23. The computer program product according to claim 22, wherein the at least one sound has a sound pressure level, wherein the sound pressure level lies in a range of 50 to 110 decibels, preferably wherein at least one, particularly preferably all or a majority of the frequency component(s) and the sound pressure level of the at least one sound are arranged within an imaginary region in a sound pressure level-frequency coordinate system, wherein the imaginary region is a triangle with:
a first corner point at 90 decibels and 900 hertz, and
a second corner point at 90 decibels and 20000 hertz, and
a third corner point at 50 decibels and 5000 hertz.

24. The computer program product according to claim 23, for warning the driver of the open vehicle, the computer program product comprising commands which, when the program is executed by an evaluation unit, cause the evaluation unit:
to receive signals from at least one surroundings sensor,
to classify a dangerous situation in the surroundings of the vehicle based on the at least one signal of the at least one surroundings sensor at least into a first class, which requires a high degree of urgency of reaction from the driver, and into a second class, which requires a low degree of urgency of reaction from the driver,
in the case of a high reaction urgency, to send or have sent at least a first sound sequence comprising at least one sound to a sound output device, and
in the case of a low reaction urgency, to send or have sent at least one second sound sequence different from the first sound sequence comprising at least one sound to a sound output device.

25. A computer-readable data carrier on which the computer program product according to claim 21 is stored.

26. A data carrier signal carrying the computer program product according to claim 21.
